(19) United States
(12) Patent Application Publication
(10) Pub. No.: US 2022/0398638 A1
(43) Pub. Date: Dec. 15, 2022

(54) SERVICE PROVISION SERVER, SERVICE PROVISION SYSTEM AND SERVICE PROVISION METHOD

(71) Applicant: Woven Planet Holdings, Inc., Tokyo (JP)

(72) Inventor: Hiroshi SAIJO, Tokyo-to (JP)

(21) Appl. No.: 17/804,186

(22) Filed: May 26, 2022

(30) Foreign Application Priority Data
Jun. 9, 2021 (JP) 2021-096900

(51) Int. Cl. G06Q 30/02; G06Q 10/00; G05B 23/02

(52) U.S. Cl. CPC G06Q 30/0283; G06Q 30/0202; G06Q 10/20; G05B 23/0283

(57) ABSTRACT

A service provision server collects and accumulates, for each vehicle, vehicle information obtained by an onboard device of the vehicle and environmental information related to a travel history of the vehicle. Next, the service provision server performs predictive diagnosis about necessity of maintenance for each vehicle, based on the accumulated vehicle information and environmental information, and generates maintenance prediction information that includes content and time of the maintenance, for each vehicle based on a result of the predictive diagnosis. Then, the service provision server predicts maintenance demand in an area where a maintenance business operator provides maintenance, based on the maintenance prediction information for a plurality of vehicles, and dynamically sets a maintenance price to be presented by the maintenance business operator, based on the predicted amount of maintenance demand and a reserve amount of maintenance resources reserved by the maintenance business operator.

### CROSS-REFERENCE TO RELATED APPLICATION

The present application claims priority under 35 U.S.C. § 119 to Japanese Patent Application No. 2021-096900, filed Jun. 9, 2021, the contents of which application are incorporated herein by reference in their entirety.

### BACKGROUND

### Field

The present disclosure relates to a service provision server, a service provision system and a service provision method for providing services that are useful at least for a maintenance workshop providing maintenance of vehicles, in a market where a vehicle manager and the maintenance workshop are a demander and a supplier, respectively.

### Background Art

WO2016/071993 discloses a technology for predicting demand for consumables of vehicles. According to the conventional technology disclosed in WO2016/071993, degrees of deterioration of consumables of each vehicle are calculated based on vehicle information collected by the vehicle and a maintenance result of the vehicle. The degrees of deterioration of the consumables are recorded to a database, and deterioration speeds of the consumables are calculated based on aggregation of the recorded deterioration degrees. Then, based on information including the deterioration degrees, the deterioration speeds, deterioration thresholds, a location of the vehicle and an area where a maintenance workshop provides services, kinds and quantities of consumables that can be required to be exchanged within a predetermined period in the maintenance workshop are calculated.

It is, however, not necessarily possible to reserve the required kinds and quantities of consumables in advance. Further, even if consumables to be exchanged can be reserved, there may be a case where it is not possible to secure personnel required for the exchange. That is, there is a possibility that the conventional technology disclosed in WO2016/071993 cannot respond to demand due to constraints of maintenance resources even if demand for maintenance is known in advance. Further, there is also a possibility that, by excessively reserving maintenance resources because of worrying about shortage of maintenance resources, costs for management of the maintenance resources and the like increase as a result.

As documents showing the technological level in the technical field of the present disclosure at the time of application, WO2018/179307 and JP2020-140245A can be exemplified in addition to WO2016/071993 above.

### SUMMARY

The present disclosure has been made in view of the problem described above. An object of the present disclosure is to provide a technology to help a maintenance business operator providing maintenance of vehicles effectively utilize maintenance resources reserved by the maintenance business operator to respond to maintenance demand.

The present disclosure provides a service provision server. The service provision server of the present disclosure is a server connected to a plurality of vehicles via a communication network, the service provision server including at least one processor, and at least one memory storing at least one program executable by the at least one processor. When being executed by the at least one processor, the at least one program causes the service provision server to execute the following processes.

In a first process by the service provision server of the present disclosure, it is executed to perform predictive diagnosis about necessity of maintenance for each of the plurality of vehicles. In a second process, it is executed to generate maintenance prediction information that includes content and time of the maintenance, for each of the plurality of vehicles based on a result of the predictive diagnosis. In a third process, it is executed to predict maintenance demand in an area where a maintenance business operator provides maintenance, based on the maintenance prediction information for the plurality of vehicles. Then, in a fourth process, it is executed to dynamically set a maintenance price to be presented by the maintenance business operator, based on the predicted maintenance demand and a reserve amount of maintenance resources reserved by the maintenance business operator.

In the present disclosure, when being executed by the at least one processor, the at least one program may cause the service provision server to execute the following additional processes. In one additional process, it is executed to transmit the maintenance prediction information to a manager of the plurality of vehicles. In another additional process, it is executed to transmit the latest dynamically set maintenance price to the manager. In still another additional process, it is executed to transmit the predicted maintenance demand to the maintenance business operator. Further, the service provision server may be caused to execute predicting a new procurement amount of the maintenance resources based on the predicted maintenance demand and the reserve amount of the maintenance resources, and transmitting the predicted new procurement amount of the maintenance resources to the maintenance business operator.

Furthermore, the service provision server may be caused to additionally execute obtaining, from each of the plurality of vehicles, vehicle information for predictive protection obtained by an onboard device, obtaining, from each of the plurality of vehicles, environmental information related to a travel history, and collecting and accumulating the vehicle information and the environmental information for each of the plurality of vehicles. In this case, the service provision server can perform the predictive diagnosis for each of the plurality of vehicles based on the accumulated vehicle information and environmental information. Further, the service provision server may be caused to additionally execute updating a predictive diagnosis model for performing the predictive diagnosis, based on the predicted maintenance demand and actual maintenance demand.

The present disclosure provides a service provision system. The service provision system of the present disclosure is a system configured by connecting at least the plurality of vehicles to the service provision server of the present disclosure via a communication network. In the service provision system of the present disclosure, each of the plurality of vehicles includes an onboard memory and an onboard processor. The onboard memory stores an operating system common to the vehicles and an application operating on the operating system and transmitting the vehicle information for predictive protection obtained by the onboard device to the server. The onboard processor executes the operating system and the application stored in the onboard memory.

The present disclosure provides a service provision method. The service provision method of the present disclosure is a method executed by a server connected to a plurality of vehicles via a communication network. The service provision method of the present disclosure includes at least the following steps.

A first step included in the service provision method of the present disclosure is a step of performing predictive diagnosis about necessity of maintenance for each of the vehicles. A second step is a step of generating maintenance prediction information that includes content and time of the maintenance, for each of the plurality of vehicles based on a result of the predictive diagnosis. A third step is a step of predicting maintenance demand in an area where a maintenance business operator provides maintenance, based on the maintenance prediction information for the plurality of vehicles. A fourth step is a step of dynamically setting a maintenance price to be presented by the maintenance business operator, based on the predicted maintenance demand and a reserve amount of maintenance resources reserved by the maintenance business operator.

The service provision method of the present disclosure may include the following additional steps. One additional step is a step of providing the maintenance prediction information for a manager of the plurality of vehicles. Another additional step is a step of providing the latest dynamically set maintenance price for the manager. Still another additional step is a step of providing the predicted maintenance demand for the maintenance business operator. The service provision method of the present disclosure may further additionally include a step of predicting a new procurement amount of the maintenance resources based on the predicted maintenance demand and the reserve amount of the maintenance resources, and a step of providing the predicted new procurement amount of the maintenance resources for the maintenance business operator.

Furthermore, the service provision method of the present disclosure may include a step of obtaining, from each of the plurality of vehicles, vehicle information for predictive protection obtained by an onboard device of the vehicle, a step of obtaining, for each of the plurality of vehicles, environmental information related to a travel history of the vehicle, and a step of collecting and accumulating the vehicle information and the environmental information for each of the vehicles. In this case, the service provision server can perform the predictive diagnosis for each of the vehicles based on the accumulated vehicle information and environmental information. Further, the service provision method of the present disclosure may further additionally include a step of updating a predictive diagnosis model for performing the predictive diagnosis, based on the predicted maintenance demand and actual maintenance demand.

Furthermore, the present disclosure provides a service provision program. The service provision program of the present disclosure is a program that includes a plurality of executable instructions for causing a computer to execute the service provision method of the present disclosure. Further, the present disclosure provides a non-transitory computer-readable storage medium in which the service provision program of the present disclosure is stored.

Demand for vehicle maintenance can be controlled by a maintenance price presented by a maintenance business operator. For example, by increasing the maintenance price, the maintenance demand can be reduced. On the contrary, by lowering the maintenance price, the maintenance demand can be increased. According to the technology of the present disclosure, the maintenance demand is predicted from a result of performing predictive diagnosis about necessity of maintenance for each vehicle. Then, the maintenance price to be presented by the maintenance business operator is dynamically set based on the predicted maintenance demand and maintenance resources reserved by the maintenance business operator. By controlling the maintenance demand by such dynamic pricing, it becomes possible for the maintenance business operator to effectively utilize the maintenance resources reserved by the maintenance business operator to respond to the maintenance demand.

### BRIEF DESCRIPTION OF THE DRAWINGS

FIG. 1 is a schematic diagram showing a configuration of a service provision system according to an embodiment of the present disclosure.

FIG. 2 is a schematic diagram showing a configuration related to a predictive diagnosis function of a service provision server and a configuration of an onboard system of a vehicle according to the embodiment of the present disclosure.

FIG. 3 is a schematic diagram showing a configuration related to a dynamic pricing function of the service provision server according to the embodiment of the present disclosure.

FIG. 4 is a sequence diagram showing a flow of a process among the service provision server, a vehicle manager, and a maintenance business operator according to the embodiment of the present disclosure.

### DETAILED DESCRIPTION

An embodiment of the present disclosure will be described below with reference to drawings. However, when a number, such as the number of elements of each kind, a quantity, an amount and a range, is stated in the embodiment shown below, the idea according to the present disclosure is not limited to the stated number unless the stated number is clearly specified or clearly theoretically identified. Further, structures and the like described in the embodiment shown below are not necessarily indispensable for the idea according to the present disclosure unless the structures and the like are clearly specified or clearly theoretically identified.

### 1. Configuration of Service Provision System and Functions of Service Provision Server

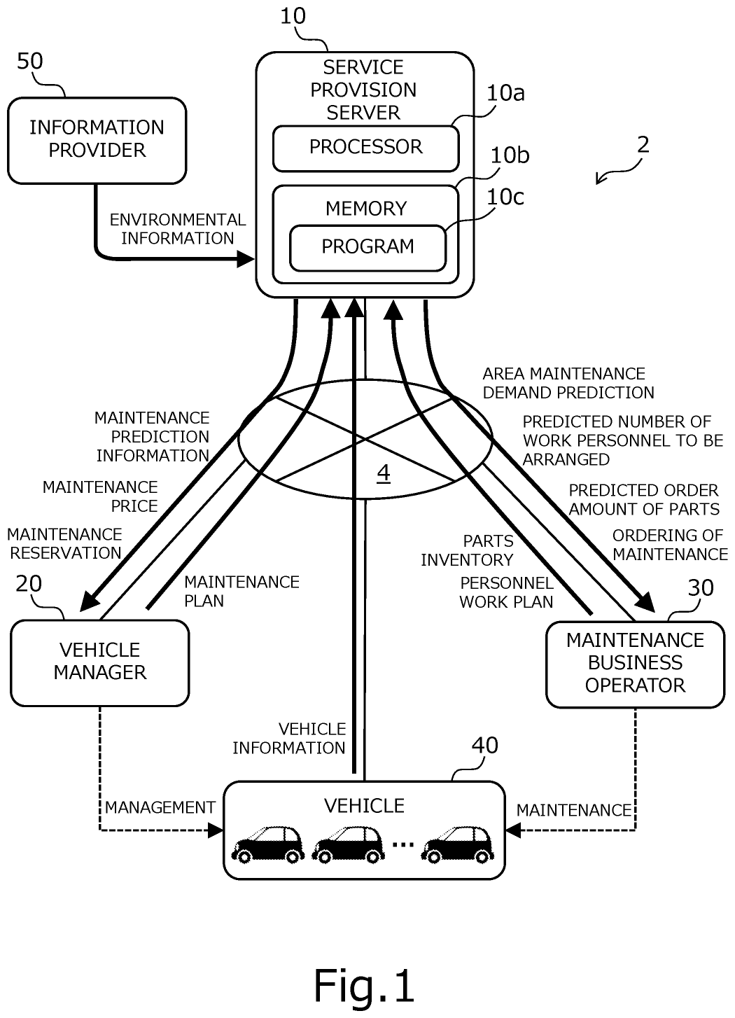

FIG. 1 is a schematic diagram showing a configuration of a service provision system according to an embodiment of the present disclosure. A service provision system 2 is a system that provides services useful for a maintenance business operator 30 that performs maintenance of vehicles 40 and services useful for a vehicle manager 20 that manages the vehicles 40. The service provision system 2 is configured by the plurality of vehicles 40 managed by the vehicle manager 20, the vehicle manager 20 and the maintenance business operator 30 being connected to a service provision server 10 via a communication network 4 including the Internet.

The vehicle manager 20 is, for example, a mobility service business operator that provides services using the vehicles 40. The services using the vehicles 40 include, for example, an online vehicle-dispatch service, a car sharing service and a ride sharing service. The vehicle manager 20 is connected to the service provision server 10 using a terminal device connectable to the communication network 4. Though there is one vehicle manager 20 connected to the service provision server 10, a plurality of vehicle managers 20 can participate in the service provision system 2. The vehicle manager 20 may be an individual or a corporation that exclusively uses the vehicles 40.

The maintenance business operator 30 may be, for example, a maintenance specialty shop specialized in maintenance of the vehicles 40 or a dealer that owns a maintenance workshop. The maintenance business operator 30 always reserves a certain amount of maintenance resources. The maintenance resources reserved by the maintenance business operator 30 include maintenance target parts (hereinafter referred to simply as parts) of the vehicles 40, which are physical resources, and work personnel for maintenance work that are human resources. Especially, the reserved parts are consumables, and the work personnel are specifically maintenance mechanics. The maintenance business operator 30 is connected to the service provision server 10 using a terminal device connectable to the communication network 4. Though there is one maintenance business operator 30 connected to the service provision server 10, a plurality of maintenance business operators 30 can participate in the service provision system 2.

The vehicles 40 targeted by management and maintenance in the service provision system 2 include, for example, internal combustion engine vehicles (ICEVs), battery electric vehicles (BEVs), hybrid electric vehicles (HEVs), plug-in hybrid electric vehicles (PHEVs) and fuel cell electric vehicles (FCEVs). When being classified by driving method, the vehicles 40 may be, for example, vehicles driven by drivers, autonomous-driving vehicles or remote-driving vehicles. When being classified by purpose, the vehicles 40 may be, for example, vehicles exclusively used by an individual or a corporation or vehicles for mobility services.

The service provision server 10 is operated by a neutral service provider different from the vehicle manager 20 and the maintenance business operator 30. The service provider receives service fees from each of the vehicle manager 20 and the maintenance business operator 30 and provides services for the vehicle manager 20 and the maintenance business operator 30 using functions of the service provision server 10. The functions of the service provision server 10 will be described below.

The service provision server 10 has a function of performing predictive diagnosis about necessity of maintenance for each vehicle 40. In order to perform the predictive diagnosis, the service provision server 10 obtains vehicle information for predictive protection from each vehicle 40 and obtains environmental information such as weather information from an information provider 50. The predictive diagnosis function of the service provision server 10 will be described in detail later.

Further, the service provision server 10 has a function of generating maintenance prediction information for each vehicle 40 based on a result of the predictive diagnosis. The maintenance prediction information is information that includes content and time of maintenance recommended to be performed for the vehicle 40. The content of maintenance includes a list of inspection positions and consumables to be exchanged. As the time of maintenance, for example, approximate time such as what year and month is shown.

The service provision server 10 transmits the maintenance prediction information to the vehicle manager 20 together with a maintenance price that is dynamically set by a dynamic pricing function described later. By receiving the maintenance prediction information generated for each vehicle 40, the vehicle manager 20 can cause each vehicle 40 to receive not too much or too little maintenance at just the right time. As a result, it is possible for the vehicle manager 20 to reduce maintenance costs for the vehicles 40.

Further, the service provision server 10 has a function of aggregating the maintenance prediction information generated for each vehicle 40 and predicting maintenance demand in an area where the maintenance business operator 30 provides maintenance. The area where the maintenance business operator 30 provides maintenance may be identified as an administrative district such as X City or Y Ward or may be identified with a distance such as a circumferential radius of Z km with the location of the maintenance business operator 30 as the center. Vehicle managers 20 developing mobility service businesses in the area where the maintenance business operator 30 provides maintenance and vehicle managers 20 owning vehicles 40 in the area are potential clients for the maintenance business operator 30.

The service provision server 10 transmits prediction of the maintenance demand in the area (hereinafter referred to as area maintenance demand prediction) to the maintenance business operator 30. By receiving the area maintenance demand prediction, the maintenance business operator 30 can optimize a reserve amount of maintenance resources to be reserved in advance. Since the area maintenance demand prediction is linked with the maintenance prediction information sent to the vehicle manager 20, imbalance between demand and supply of maintenance of the vehicles 40 between the vehicle manager 20 and the maintenance business operator 30 is suppressed.

Further, the service provision server 10 receives information about a reserve amount of maintenance resources that the maintenance business operator 30 reserves at a current point of time, specifically, parts inventory and a personnel work plan. Then, the service provision server 10 predicts a new procurement amount of maintenance resources based on the area maintenance demand prediction and the reserve amount of maintenance resources. The predicted new procurement amount of maintenance resources includes a predicted order amount of parts and a predicted number of work personnel to be arranged. For example, if the reserve amount of maintenance resources is insufficient relative to the area maintenance demand prediction, the new procurement amount is calculated so that maintenance resources that meet the area maintenance demand prediction can be reserved. The service provision server 10 transmits the predicted new procurement amount of maintenance resources to the maintenance business operator 30.

Furthermore, the service provision server 10 dynamically sets a maintenance price to be presented by the maintenance business operator 30, based on the area maintenance demand prediction and the reserve amount of maintenance resources. For example, if the reserve amount of maintenance resources is insufficient relative to the area maintenance demand prediction, the maintenance demand can be driven in a downward direction by increasing the maintenance price to be presented. On the contrary, if the reserve amount of maintenance resources is excessive relative to the area maintenance demand prediction, the maintenance demand can be driven in an upward direction by decreasing the maintenance price to be presented. By controlling the maintenance demand by such dynamic pricing, it becomes possible for the maintenance business operator 30 to effectively utilize the maintenance resources the maintenance business operator 30 reserves to respond to the maintenance demand.

Further, the service provision server 10 mediates acceptance, ordering and reservation of maintenance. First, the service provision server 10 accepts maintenance plans from the vehicle manager 20. Each maintenance plan includes, an ID of a vehicle 40 to receive maintenance, content of the maintenance, desired time of the maintenance and the like. The vehicle manager 20 can make the maintenance plan for each vehicle 40 based on the maintenance prediction information described before.

Next, the service provision server 10 compares the maintenance plans accepted from the vehicle manager 20 with the parts inventory and the personnel work plan of the maintenance business operator 30 to decide a maintenance schedule. When the maintenance schedule is decided, the service provision server 10 gives an order for maintenance to the maintenance business operator 30. The order for maintenance includes the IDs of the vehicles 40 to receive maintenance, the content of the maintenance, the maintenance schedule and the like. Further, the service provision server 10 notifies the vehicle manager 20 of the content and schedule for the reserved maintenance and a maintenance price.

The service provision server 10 having the above functions is a computer or a computer group that is provided with at least one processor 10a (hereinafter collectively called a processor) and at least one memory 10b (hereinafter collectively called a memory) combined with the processor 10a. In the memory 10b, at least one program 10c (hereinafter collectively called a program) that is executable by the processor 10a and various data related to the program 10c are stored. By the program 10c being executed by the processor 10a, each of the above functions is realized in the service provision server 10. The memory 10b includes a main storage and an auxiliary storage. The program 10c and the data can be stored in the main memory or can be also stored in a computer-readable storage medium which is an auxiliary storage.

### 2. Details of Predictive Diagnosis Function of Service Provision Server

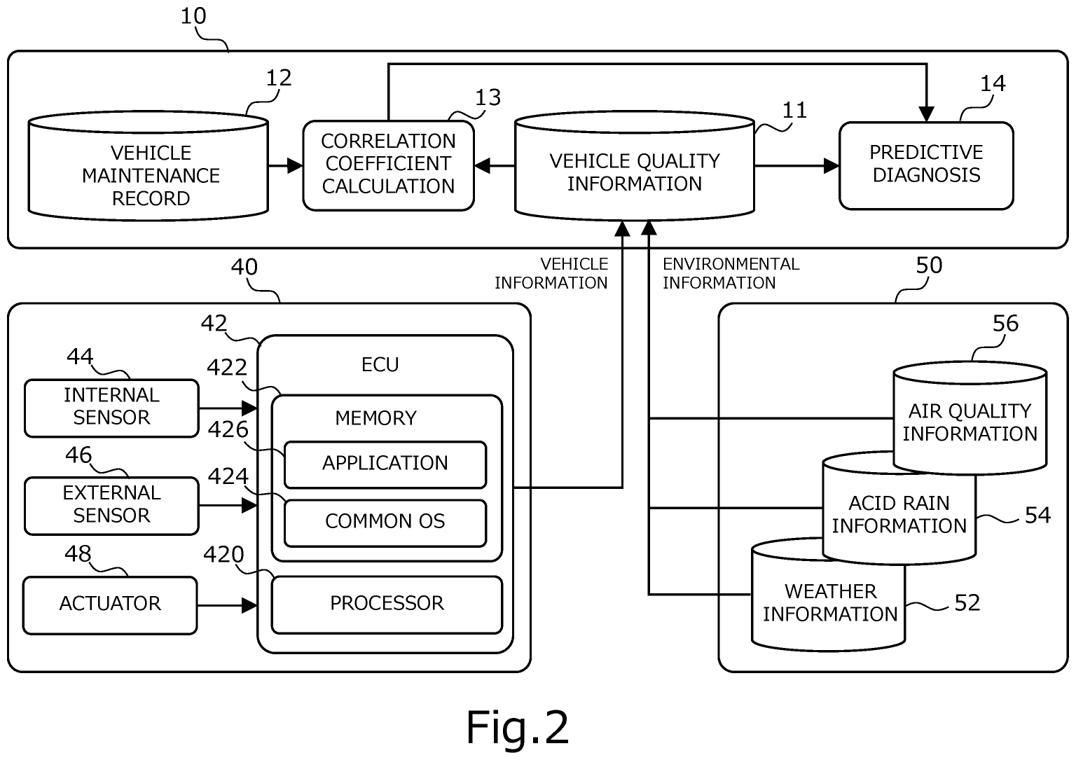

Next, details of the predictive diagnosis function of the service provision server 10 will be described with reference to FIG. 2. FIG. 2 shows a configuration related to the predictive diagnosis function of the service provision server 10 and a configuration of an onboard system of each vehicle 40 for obtaining vehicle information used for predictive diagnosis.

In the predictive diagnosis by the service provision server 10, the vehicle information for predictive protection obtained by each vehicle 40 and the environmental information related to a travel history of each vehicle 40 are used. The environmental information is distributed from the information provider 50 which is a weather information provision company or the like. The information provider 50 has various kinds of databases storing environmental information, such as a weather information database 52, an acid rain information database 54 and an air quality information database 56. From the environmental information registered with these databases, information requested by the service provision server 10, specifically, information about environmental conditions that influence the quality of each vehicle 40 is periodically distributed to the service provision server 10. The environmental conditions that influence the quality of each vehicle 40 are, for example, weather, temperature, humidity, acid rain, air quality and the like.

The vehicle information is obtained by an onboard device of each vehicle 40, for example, an internal sensor 44, an external sensor 46 and an actuator 48. The internal sensor 44 is typically a state sensor that obtains information about motion of the vehicle 40. As the state sensor, for example, a wheel speed sensor, an acceleration sensor, an angular velocity sensor and a steering angle sensor are exemplified. The external sensor 46 is typically a recognition sensor that obtains information for recognizing a situation around the vehicle 40. As the recognition sensor, a camera, a LiDAR (Laser Imaging Detection and Ranging) and a millimeter-wave sensor are exemplified. Further, as the external sensor 46, a GPS sensor for estimating a position of the vehicle 40 itself is also included. From the GPS sensor, information about the travel history of the vehicle 40 is obtained. The actuator 48 is typically a steering device to steer the vehicle 40, a driving device to drive the vehicle 40 and a braking device to brake the vehicle 40. From the actuator 48, information showing an operation state of the actuator 48 is obtained.

Each vehicle 40 is provided with an ECU (Electronic Control Unit) 42. The various kinds of information obtained by the onboard device described above is inputted to the ECU 42. The ECU 42 is provided with at least one onboard processor 420 (hereinafter collectively referred to as an onboard processor) and at least one onboard memory 422 (hereinafter collectively referred to as an onboard memory) combined with the onboard processor 420. In the onboard memory 422, an operating system 424 common to the vehicles 40 targeted by management and maintenance in the service provision system 2 and applications 426 that operates on the operating system 424 are stored.

The applications 426 include an application for transmitting the vehicle information for predictive protection obtained by the onboard device to the service provision server 10. By the operating system 424 and the applications 426 being executed by the onboard processor 420, the vehicle information obtained by the onboard device including the internal sensor 44, the external sensor 46 and the actuator 48 is transmitted to the service provision server 10. Transmission of the vehicle information by the ECU 42 is periodically performed.

In the present embodiment, any of the vehicles 40 targeted by management and maintenance in the service provision system 2 has the operating system 424 common to the vehicles 40. Therefore, hardware difference among the vehicles 40 is absorbed by the operating system 424. Further, variation of definitions of information among the vehicles 40 is eliminated by the operating system 424 common to the vehicles 40, and processing of information requested by the service provision server 10 becomes easy. As a result, in the service provision system 2, the vehicle information obtained from the vehicles 40 is improved in both of quality and quantity in comparison with vehicle information obtained from vehicles that do not have the common operating system 424.

The service provision server 10 is provided with a vehicle quality information database 11, a vehicle maintenance record database 12, a correlation coefficient calculation unit 13 and a predictive diagnosis unit 14. The vehicle quality information database 11 and the vehicle maintenance record database 12 are stored in the memory 10b. The correlation coefficient calculation unit 13 and the predictive diagnosis unit 14 are realized as functions of the service provision server 10 by the program 10c being executed by the processor 10a.

The service provision server 10 collects the vehicle information transmitted from the vehicles 40 and the environmental information provided by the information provider 50. The collected vehicle information and environmental information are accumulated in the vehicle quality information database 11. The predictive diagnosis unit 14 obtains the vehicle information from the vehicle quality information database 11 for each vehicle 40 and, based on the travel history of the vehicle 40 included in the vehicle information, extracts the environmental information related to the travel history of the vehicle 40 from the vehicle quality information database 11. The predictive diagnosis unit 14 extracts, for example, information that acid rain was falling in an area where a vehicle 40 was driven or information that a place where a vehicle 40 was parked was highly humid.

For each vehicle 40, the predictive diagnosis unit 14 performs predictive diagnosis of maintenance target parts, based on the vehicle information obtained from the vehicle quality information database 11 and the environmental information related to the travel history of the vehicle 40. From the vehicle information, information about deterioration degrees and deterioration speeds of the maintenance target parts and information about failure signs can be obtained. By combining the environmental information about environments to which the vehicle 40 has been exposed with the pieces of information, it becomes possible to accurately determine whether maintenance is required or not. For the predictive diagnosis by the predictive diagnosis unit 14, a predictive diagnosis model is used. As the predictive diagnosis model, for example, a machine learning model using the Bayesian theory or deep learning can be used.

In the vehicle maintenance record database 12, maintenance records for each vehicle 40 are recorded. The recorded maintenance records include dates and time when maintenance was performed, content of the maintenance including names of exchanged parts. The correlation coefficient calculation unit 13 compares prediction of maintenance based on the information accumulated in the vehicle quality information database 11 with the results of maintenance recorded to the vehicle maintenance record database 12 to calculate a correlation coefficient (or a coefficient function). The correlation coefficient calculated by the correlation coefficient calculation unit 13 is used to update the predictive diagnosis model used by the predictive diagnosis unit 14. Calculation of the correlation coefficient by the correlation coefficient calculation unit 13 and update of the predictive diagnosis model using the correlation coefficient are periodically repeated.

As described above, the service provision server 10 obtains the vehicle information improved in both of quality and quantity from each vehicle 40 and obtains the environmental information related to environmental conditions that influence the quality of the vehicle 40. By using the information about environment, which is an external factor, in addition to the vehicle information obtained by each individual vehicle 40 in predictive diagnosis about necessity of maintenance, it is possible to enhance the accuracy of the predictive diagnosis. Furthermore, since the predictive diagnosis model used in the predictive diagnosis is repeatedly updated based on results of maintenance of each vehicle 40, the accuracy of the predictive diagnosis is improved over time. The service provision server 10 generates each of the maintenance prediction information for the vehicle manager 20 and the area maintenance demand prediction for the maintenance business operator 30 based on a result of the predictive diagnosis performed with a high accuracy as described above.

### 3. Details of Dynamic Pricing Function of Service Provision Server

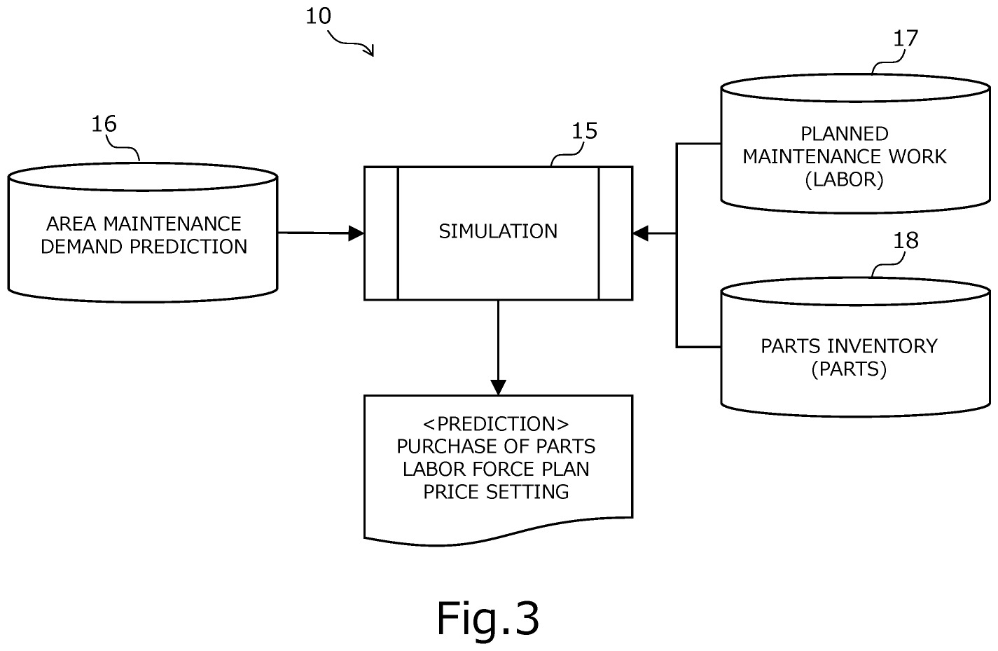

Next, details of the dynamic pricing function of the service provision server 10 will be described with reference to FIG. 3. In FIG. 3, a configuration related to the dynamic pricing function of the service provision server 10 is shown.

The service provision server 10 is provided with a simulation unit 15, an area maintenance demand prediction database 16, a planned maintenance work database 17 and a parts inventory database 18. Each of the databases 16, 17 and 18 is stored in the memory 10b. The simulation unit 15 is realized as a function of the service provision server 10 by the program 10c being executed by the processor 10a.

In the area maintenance demand prediction database 16, area maintenance demand prediction for each area is stored. In the planned maintenance work database 17, a personnel work plan transmitted from the maintenance business operator 30 is stored. In the parts inventory database 18, parts inventory transmitted from the maintenance business operator 30 is stored. The simulation unit 15 performs demand inventory simulation using information obtained from these databases 16, 17 and 18. In the demand inventory simulation, a new procurement amount of maintenance resources required for the maintenance business operator 30 to reserve maintenance resources that meet the area maintenance demand prediction is predicted. The new procurement amount of maintenance resources includes a predicted order amount of parts and a predicted number of work personnel to be arranged.

The simulation unit 15 simulates such a maintenance price that maintenance resources of the maintenance business operator 30 can be effectively utilized to the maximum, using the information obtained from the databases 16, 17 and 18 described above. As a specific example, dynamic pricing by machine learning is performed. The maintenance price set by dynamic pricing is presented to the vehicle manager 20 from the service provision server 10.

Thus, in the service provision system 2, setting of the maintenance price is performed by the service provision server 10 on behalf of the maintenance business operator 30. The service provision server 10 is a neutral existence that has information about both of demand and supply required for dynamic pricing and that belongs to neither the vehicle manager 20 nor the maintenance business operator 30. Therefore, the maintenance price dynamically set by the service provision server 10 is a market-linked fair price without a bias toward any one of the vehicle manager 20 and the maintenance business operator 30. For this reason, the maintenance business operator 30 can trust the service provision server 10 to set the maintenance price. Further, the vehicle manager 20 can trust and accept the maintenance price presented by the service provision server 10.

### 4. Flow of Process Among Service Provision Server, Vehicle Manager and Maintenance Business Operator

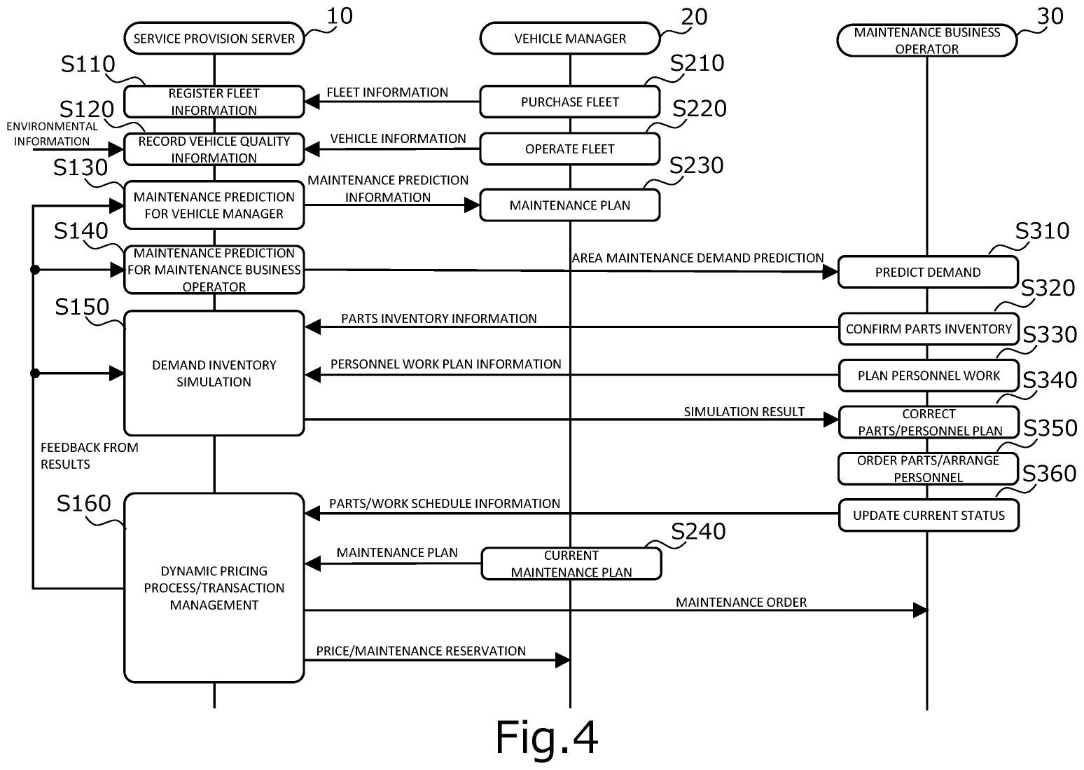

The functions of the service provision system 2 have been described mainly on the functions of the service provision server 10. Next, a flow of a process among the service provision server 10, the vehicle manager 20 and the maintenance business operator 30 will be described with reference to the sequence diagram of FIG. 4. The flow of the process in the sequence diagram also shows a service provision method executed by the service provision server 10.

For example, when the vehicle manager 20 develops a mobility service business, the vehicle manager 20 purchases a fleet of vehicles 40 to enjoy the services by the service provision system 2. Then, the vehicle manager 20 provides fleet information about the purchased fleet for the service provision server 10 (step S210). The fleet information includes, for example, information such as the ID, vehicle type and maintenance target parts of each of the vehicles 40 included in the fleet. The service provision server 10 registers the fleet information provided from the vehicle manager 20 with a database (step S110).

While operating the fleet of the vehicles 40, the vehicle manager 20 provides vehicle information obtained from each vehicle 40 for the service provision server 10 (step S220). The service provision server 10 records the vehicle information obtained from the vehicle manager 20 and environmental information related to a travel history of each vehicle 40 as vehicle quality information (step S120).

The service provision server 10 performs maintenance prediction, that is, predictive diagnosis about necessity of maintenance for the vehicle manager 20 based on the vehicle quality information. Then, the service provision server 10 creates maintenance prediction information based on a result of the predictive diagnosis and provides the maintenance prediction information for the vehicle manager 20 (step S130). The maintenance prediction information provided at this time includes a current maintenance price set by a dynamic pricing process performed later. The vehicle manager 20 creates a maintenance plan based on the provided maintenance prediction information (step S230).

Next, the service provision server 10 performs maintenance prediction for the maintenance business operator 30, that is, prediction of maintenance demand in an area where the maintenance business operator 30 provides maintenance. Then, the service provision server 10 creates area maintenance demand prediction based on a result of the prediction and provides the area maintenance demand prediction for the maintenance business operator 30 (step S140). The maintenance business operator 30 immediately uses the provided area maintenance demand prediction or performs demand prediction based thereon (step S310).

The maintenance business operator 30 confirms inventory of parts that the maintenance business operator 30 holds and provides information about parts inventory for the service provision server 10 (step S320). Further, the maintenance business operator 30 formulates a work plan for work personnel to perform maintenance work and provides information about the personnel work plan for the service provision server 10 (step S330). The service provision server 10 performs demand inventory simulation based on the provided parts inventory information and personnel work plan information, and the area maintenance demand prediction (step S150). A result of the demand inventory simulation is provided for the maintenance business operator 30.

The maintenance business operator 30 corrects each of the plan for parts to be reserved and the plan for work personnel based on the predicted order amount of parts and the predicted number of work personnel to be arranged provided as the result of the demand inventory simulation (step S340). Then, the maintenance business operator 30 gives an order of parts and arranges work personnel based on the corrected plans (step S350). The maintenance business operator 30 updates the current parts inventory status and work schedule each time and provides information thereabout for the service provision server 10 (step S360). Further, the vehicle manager 20 provides the decided current maintenance plan for the service provision server 10 (step S240).

The service provision server 10 sets a maintenance price by dynamic pricing based on the parts inventory information, the personnel work plan information and the area maintenance demand prediction. The set maintenance price is fed back to the process of step S130. Further, the service provision server 10 manages transactions between the vehicle manager 20 and the maintenance business operator 30. In particular, the service provision server 10 compares the maintenance plan accepted from the vehicle manager 20 with the parts inventory status and work schedule of the maintenance business operator 30 and decides the schedule for maintenance. After the maintenance schedule is decided, the service provision server 10 gives an order of maintenance to the maintenance business operator 30 and notifies the vehicle manager 20 of decision of reservation of maintenance and the maintenance price. When maintenance is performed, information about the result thereof is fed back to the processes of steps S130, S140 and S150 (step S160).

What is claimed is:

1. A service provision server connected to a plurality of vehicles via a communication network, the service provision server comprising:
at least one processor; and
at least one memory storing at least one program executable by the at least one processor; wherein
the at least one program is configured to, when being executed by the at least one processor, cause the service provision server to execute
performing predictive diagnosis about necessity of maintenance for each of the plurality of vehicles,
generating maintenance prediction information that includes content and time of the maintenance, for each of the vehicles based on a result of the predictive diagnosis,
predicting maintenance demand in an area where a maintenance business operator provides maintenance, based on the maintenance prediction information for the plurality of vehicles, and
dynamically setting a maintenance price to be presented by the maintenance business operator, based on predicted maintenance demand and a reserve amount of maintenance resources reserved by the maintenance business operator.

2. The service provision server according to claim 1, wherein the at least one program is configured to, when being executed by the at least one processor, further cause the service provision server to execute transmitting the maintenance prediction information to a manager of the plurality of vehicles.

3. The service provision server according to claim 2, wherein the at least one program is configured to, when being executed by the at least one processor, further cause the service provision server to execute transmitting a latest dynamically set maintenance price to the manager.

4. The service provision server according to claim 1, wherein the at least one program is configured to, when being executed by the at least one processor, further cause the service provision server to execute transmitting the predicted maintenance demand to the maintenance business operator.

5. The service provision server according to claim 1, wherein,
the at least one program is configured to, when being executed by the at least one processor, further cause the service provision server to execute
predicting a new procurement amount of the maintenance resources based on the predicted maintenance demand and the reserve amount of the maintenance resources, and
transmitting predicted new procurement amount of the maintenance resources to the maintenance business operator.

6. The service provision server according to claim 1, wherein,
the at least one program is configured to, when being executed by the at least one processor, further cause the service provision server to execute
obtaining, from each of the plurality of vehicles, vehicle information for predictive protection obtained by an onboard device,
obtaining, for each of the plurality of vehicles, environmental information related to a travel history,
collecting and accumulating the vehicle information and the environmental information for each of the plurality of vehicles, and
performing the predictive diagnosis for each of the plurality of vehicles based on the vehicle information and the environmental information.

7. The service provision server according to claim 6, wherein the at least one program is configured to, when being executed by the at least one processor, further cause the service provision server to execute updating a predictive diagnosis model for performing the predictive diagnosis, based on the predicted maintenance demand and actual maintenance demand.

8. A service provision system configured by connecting at least the plurality of vehicles to the service provision server according to claim 6 via the communication network, wherein
each of the plurality of vehicles comprises
an onboard memory storing an operating system common to the plurality of vehicles and an application operating on the operating system and transmitting the vehicle information for predictive protection obtained by the onboard device to the service provision server, and
an onboard processor executing the operating system and the application.

9. A service provision method executed by a computer connected to a plurality of vehicles via a communication network, the service provision method comprising:
performing predictive diagnosis about necessity of maintenance for each of the plurality of vehicles;
generating maintenance prediction information that includes content and time of the maintenance, for each of the plurality of vehicles based on a result of the predictive diagnosis;
predicting maintenance demand in an area where a maintenance business operator provides maintenance, based on the maintenance prediction information for the plurality of vehicles; and
dynamically setting a maintenance price to be presented by the maintenance business operator, based on predicted maintenance demand and a reserve amount of maintenance resources reserved by the maintenance business operator.

10. The service provision method according to claim 9, further comprising providing the maintenance prediction information for a manager of the plurality of vehicles.

11. The service provision method according to claim 10, further comprising providing a latest dynamically set maintenance price for the manager.

12. The service provision method according to claim 9, further comprising providing the predicted maintenance demand for the maintenance business operator.

13. The service provision method according to claim 9, further comprising
predicting a new procurement amount of the maintenance resources based on the predicted maintenance demand and the reserve amount of the maintenance resources, and
providing predicted new procurement amount of the maintenance resources for the maintenance business operator.
